(19) United States
(12) Patent Application Publication
(10) Pub. No.: US 2021/0082268 A1
(43) Pub. Date: Mar. 18, 2021

(54) CONSTRUCTION MACHINE WORK INFORMATION MANAGEMENT SYSTEM

(71) Applicant: KOBELCO CONSTRUCTION MACHINERY CO., LTD., Hiroshima-shi, Hiroshima (JP)

(72) Inventors: Takayuki DOI, Hiroshima (JP); Nobuhiro FUKUO, Hiroshima (JP); Koji YAMASHITA, Hiroshima (JP); Yoichiro YAMAZAKI, Hiroshima (JP)

(73) Assignee: Kobelco Construction Machinery Co., Ltd., Hiroshima-shi, Hiroshima (JP)

(21) Appl. No.: 16/979,424

(22) PCT Filed: Feb. 1, 2019
(86) PCT No.: PCT/JP2019/003579

§ 371 Date: Sep. 9, 2020

(30) Foreign Application Priority Data
Mar. 28, 2018 (JP) 2018-061967

(51) Int. Cl. G08B 21/02; G08C 17/02

(52) U.S. Cl. CPC G08B 21/02; G08C 17/02

(57) ABSTRACT

A construction machine work information management system includes: a server; a transmission unit attached to the construction machine and configured to transmit a wireless signal indicating first identification information for identifying the transmission unit itself; and reception units disposed at a plurality of monitoring target positions at a work site, the reception units being configured to receive the wireless signal when the construction machine approaches, and to transmit second identification information for identifying the reception unit itself to the server together with the first identification information. The server includes: a storage unit; and a data processing unit configured to store, in the storage unit, an information group in which predetermined information based on at least one of the first and the second identification information and time information indicating time of the reception are associated with each other, every time the first and the second identification information are received.

### TECHNICAL FIELD

The present invention relates to a system for managing information regarding work of a construction machine such as a hydraulic excavator.

### BACKGROUND ART

Construction machines such as hydraulic excavators have been conventionally used at various work sites. In work using this type of construction machine, for example, as shown in Patent Literature 1, a technology is known that detects the approach of the construction machine to a specified external object and generates an alert output by performing communication between a contact prevention device provided in the construction machine and an IC tag attached to the specified external object. In addition, for example, Patent Literature 2 also describes the same type of technology as in Patent Literature 1.

In that connection, at various work sites that use construction machines, it is desirable to determine the actual operation status of the construction machine at the work site in order to determine the progress status of the work, manage the work process, determine whether details of the work is appropriate, and the like.

In this case, it is considered, for example, to install a surveillance camera at the work site, and to capture a moving image of the work status at the work site with the surveillance camera.

However, such a technology requires a work administrator or the like to perform work of playing back and viewing the captured moving image, and thus the work man-hour is likely to be a heavy burden. In particular, at a work site that needs a plurality of surveillance cameras, a large number of man-hours are required for the work.

In addition, in general, the captured moving image includes many images that are not needed very much, and a portion of interest is often hidden behind another object. In particular, when the moving image is long, it is easy to overlook an important image. Therefore, it can be difficult to efficiently and accurately determine the work status even when viewing the moving image captured at the work site.

### CITATION LIST

### Patent Literature

Patent Literature 1: Japanese Patent Application Laid-Open No. 2008-123014

Patent Literature 2: Japanese Patent Application Laid-Open No. 2005-346228

### SUMMARY OF INVENTION

The present invention has been made in view of such a background, and an object of the present invention is to provide a work information management system that can efficiently and appropriately determine the work status of the construction machine at the work site.

A construction machine work information management system according to one aspect of the present invention includes:
a server;
a transmission unit attached to the construction machine and configured to transmit a wireless signal indicating first identification information for identifying the transmission unit itself; and
a plurality of reception units disposed at a plurality of monitoring target positions at a work site of the construction machine, the reception units being configured to receive the wireless signal when the construction machine approaches.

When receiving the wireless signal, each of the plurality of reception units transmits second identification information for identifying the reception unit itself to the server together with the first identification information indicated by the received wireless signal.

The server includes:
a work information storage unit; and
a data processing unit configured to store, in the work information storage unit, an information group in which predetermined information based on at least one of the received first identification information and the second identification information and time information indicating time of the reception are associated with each other, every time the first identification information and the second identification information are received from each of the reception units.

The above configuration makes it possible to efficiently and appropriately determine the work status of the construction machine at the work site.

### BRIEF DESCRIPTION OF DRAWINGS

FIG. 1 is a diagram illustrating an entire configuration of a work information management system and a work site of a first embodiment of the present invention.

FIG. 2 is a diagram showing a configuration of a transmission unit (ID tag) included in the work information management system of the embodiment.

FIG. 3 is a flowchart showing processing of a work information server shown in FIG. 1.

FIG. 4 is a block diagram showing a main configuration of a work information management system of a second embodiment of the present invention.

FIG. 5 is a block diagram showing a main configuration of a work information management system of a third embodiment of the present invention.

FIG. 6A is a diagram showing another example of an attachment position of the transmission unit to a construction machine.

FIG. 6B is a diagram showing another example of the attachment position of the transmission unit to the construction machine.

### DESCRIPTION OF EMBODIMENTS

### First Embodiment

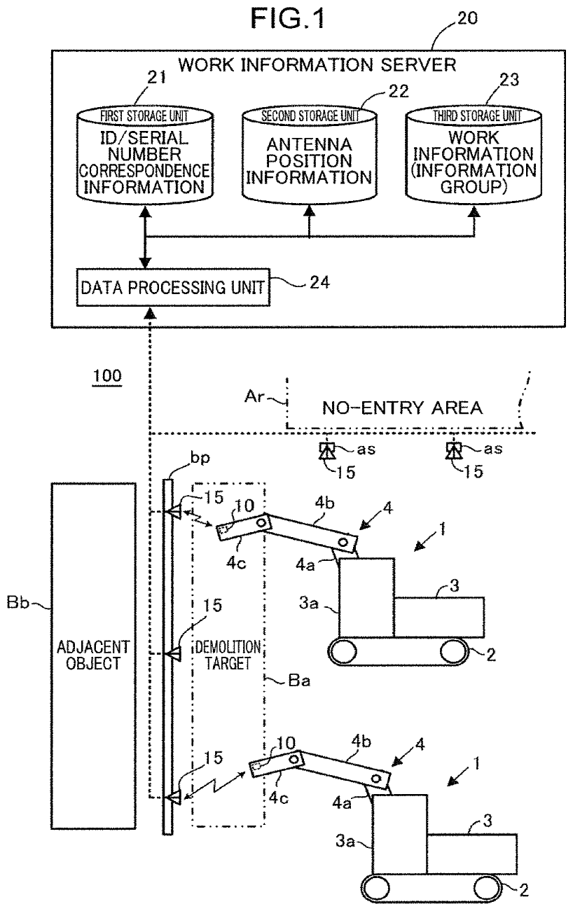

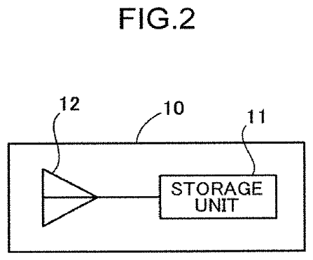

A work information management system 100 according to a first embodiment of the present invention will be described with reference to FIGS. 1 and 2. With reference to FIG. 1, the work information management system 100 of the present embodiment includes an ID tag 10 serving as a transmission unit individually attached to each construction machine 1 that performs work at a work site, an antenna device 15 serving as a reception unit disposed at each of a plurality of monitoring target positions at the work site, and a work information server 20 disposed in an office at the work site or the like.

Note that in FIG. 1, as one example of the work site, a work site for performing demolition work on a demolition target Ba such as a building or a house is assumed. FIG. 1 schematically indicates respective construction machines 1 in side view. The demolition target Ba, an adjacent object Bb adjacent to the demolition target Ba, and a no-entry area Ar in FIG. 1 represent respective disposition positions when the work site is viewed in plan view.

Each construction machine 1 is, for example, a hydraulic excavator having a known configuration, and includes a travelling body 2, a stewing body 3 serving as a machine body rotatably mounted on the travelling body 2, and a work device 4 including a boom 4a, an arm 4b, and an attachment 4c.

The boom 4a of the work device 4 is swingably extended from the stewing body 3 on the side of a cab 3a provided forward of the stewing body 3. The arm 4b is swingably extended from the tip of the boom 4a. The attachment 4c is swingably attached to the tip of the arm 4b. A wide variety of attachments 4c can be used according to details of the work to be performed by the construction machine 1. For example, when performing demolition work, an attachment for demolition work such as a crusher is used as the attachment 4c.

The ID tag 10 is a so-called RF-ID tag. As shown in FIG. 2, the ID tag 10 includes a storage unit 11 that stores and holds first identification information for identifying the ID tag 10 itself (hereinafter referred to as ID information) such as an intrinsic identification number for individual ID tag 10, and an antenna 12 that transmits the ID information to the outside with a wireless signal of a predetermined frequency range. In this case, the wireless signal that can be transmitted from the antenna 12 of the ID tag 10 is a signal with relatively weak strength, and can be received at a position close to the ID tag 10 from several centimeters to several meters from the ID tag 10.

In the present embodiment, each ID tag 10 is attached to a predetermined part of the work device 4 of each construction machine 1, for example, to the attachment 4c as a part near the tip of the work device 4. Therefore, by determining the position of each ID tag 10, it is possible to determine at which position each construction machine 1 is performing work with the attachment 4c.

Note that the ID tag 10 may be either of a passive type without a power battery or an active type with a power battery.

The antenna device 15 serving as a reception unit receives the wireless signal transmitted from the ID tag 10. The position where each antenna device 15 is disposed is a position where the approach of the work device 4 of the construction machine 1 should be avoided as much as possible in the present embodiment.

For example, in the example shown in FIG. 1, the adjacent object Bb, which is not a demolition target, exists adjacent to the demolition target Ba, and the no-entry area Ar, which prohibits the entry of the construction machine 1, exists at the work site. In this example, a plurality of antenna devices 15 is attached to a shield such as a protective net bp disposed between the demolition target Ba and the adjacent object Bb at appropriate intervals. In addition, one or more antenna devices 15 are attached to each of installation objects such as a plurality of columns as installed near a boundary of the no-entry area Ar so as to surround the no-entry area Ar.

Specifically, the antenna device 15 includes an antenna that receives the wireless signal transmitted from the ID tag 10, an amplifier that amplifies the signal received by the antenna, an A/D (analog/digital) converter that converts the amplified signal into data, a memory in which antenna identification information for identifying the antenna device 15 (second identification information) is stored in advance, an interface circuit that communicates with the work information server 20, and the like. When the ID tag 10 is of a passive type, the antenna device 15 that supports the ID tag 10 is configured to transmit power supply to the ID tag 10. In the present embodiment, the antenna device 15 is configured, when receiving the wireless signal from the ID tag 10, to transmit the antenna identification information for identifying individual antenna device 15 to the work information server 20 together with the ID information indicated by the received wireless signal.

The work information server 20 includes, for example, one or more electronic circuit units including a microcomputer, memory, interface circuit, and the like, one or more computers, or a combination thereof. The work information server 20 receives the signal transmitted by each antenna device 15.

Note that the interface circuits provided in the antenna device 15 and the work information server 20 are configured to communicate with each other via a network such as a local area network (LAN). However, the interface circuits are not limited to this configuration, but the interface circuits provided in the antenna device 15 and the work information server 20 may be configured to directly perform wireless communication with each other, for example, by Bluetooth (registered trademark), not via a network. Alternatively, the interface circuits provided in the antenna device 15 and the work information server 20 may be configured to directly communicate with each other via a communication cable.

The work information server 20 includes a first storage unit 21, a second storage unit 22, a third storage unit (work information storage unit) 23, and a data processing unit 24 as functional units configured by both or one of an installed hardware configuration and a program (software configuration). The first storage unit 21 stores in advance ID/serial number correspondence information indicating a correspondence between the ID information of each ID tag 10 and serial number information (intrinsic information) as identification information of the construction machine 1 to which the ID tag 10 is attached. The second storage unit 22 stores in advance antenna position information indicating a correspondence between position information indicating a disposition position of each antenna device 15 and the antenna identification information of the antenna device 15. The third storage unit 23 stores work information, which will be described later, regarding reception of the ID information of the ID tag 10 corresponding to each construction machine 1 by the data processing unit 24. The data processing unit 24 performs data processing such as storing the work information in the third storage unit 23.

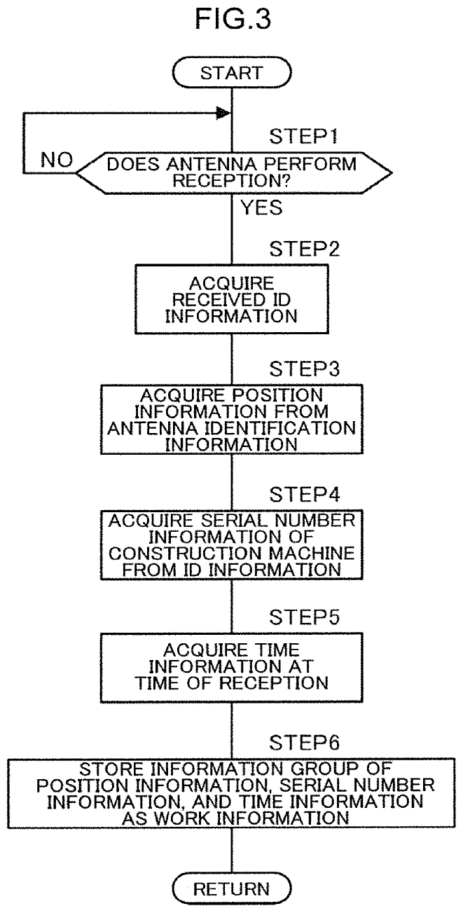

Next, an operation of the work information management system 100 of the present embodiment will be described. The data processing unit 24 of the work information server 20 performs processing shown in a flowchart of FIG. 3 in a status where work is being performed at the work site.

In STEP 1, the data processing unit 24 sequentially monitors whether any antenna device 15 has received the ID information. Specifically, when the interface circuit of the work information server 20 receives the ID information from the antenna device 15 together with the antenna identification information, the data processing unit 24 determines that the antenna device 15 has received the ID information. Then, when the data processing unit 24 determines that any antenna device 15 has received the ID information (YES in STEP 1), the data processing unit 24 performs processing of STEPS 2 to 6.

In STEP 2, the data processing unit 24 acquires the ID information received from the antenna device 15 by the interface circuit of the work information server 20. In STEP 3, the data processing unit 24 acquires the antenna identification information received by the interface circuit of the work information server 20 from the antenna device 15 together with the ID information. Then, in the antenna position information stored in the second storage unit 22, the data processing unit 24 acquires the position information indicating the disposition position of the antenna 15 that has received the ID information (monitoring target position), the position information being associated with the acquired antenna identification information.

Furthermore, in STEP 4, in the ID/serial number correspondence information stored in the first storage unit 21, the data processing unit 24 acquires the serial number information of the construction machine 1 associated with the ID information acquired in STEP 2. In STEP 5, the data processing unit 24 acquires time information indicating the time when the interface circuit receives the ID information and the antenna identification information.

Then, in STEP 6, the data processing unit 24 stores, in the third storage unit 23, an information group in which the position information, the serial number information, and the time information, which are respectively acquired in STEPS 3 to 5, are associated with each other, as one group of the work information regarding an event that the tip (attachment 4c) of the work device 4 of any construction machine 1 approaches any monitoring target position.

As described above, the data processing unit 24 performs the processing of STEPS 2 to 6 every time any antenna device 15 receives the ID information from the ID tag 10 and the interface circuit of the work information server 20 receives the ID information and the antenna identification information from the antenna device 15.

By this operation, every time the event occurs that the tip (attachment 4c) of the work device 4 of any construction machine 1 approaches any monitoring target position (disposition position of any antenna device 15), the third storage unit 23 stores cumulatively the work information as the information group in which the position information indicating the disposition position of the antenna device 15, the serial number information of the construction machine 1, and the time information indicating the time when the event has occurred are associated with each other. Therefore, a history of the work information regarding the event (information group) is stored in the third storage unit 23.

Then, when a predetermined operation of the work information server 20 is performed, the data processing unit 24 outputs a list of the history of the work information stored and held in the third storage unit 23 to a display or printer (not shown) or transfers the list to an external data base server or the like.

In this case, the data processing unit 24 can output the history of the work information (information group) after sorting according to the position information, the serial number information, or the like.

This allows an administrator, responsible person, or the like of the work site to easily acquire useful information regarding the approach of the construction machine 1 to the monitoring target position as a position to avoid the construction machine 1 coming too close as much as possible (disposition position of the antenna device 15) at the work site.

Therefore, for example, when the work device 4 of the construction machine 1 of a certain serial number frequently approaches the monitoring target position, it is possible to alert a driver of the construction machine 1. When an event occurs frequently that the work device 4 of any construction machine 1 approaches a certain monitoring target position, or when the event frequently occurs in a certain time zone, it is possible to take measures such as reviewing the work process promptly.

### Second Embodiment

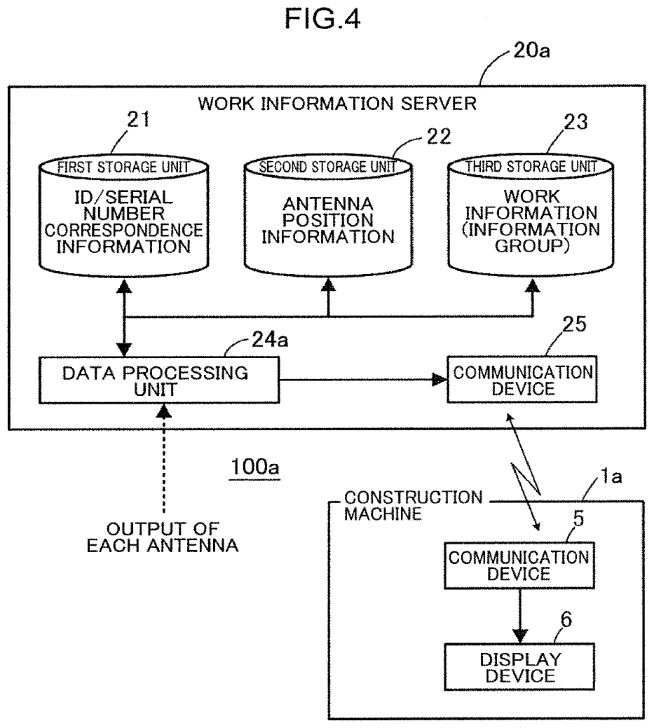

Next, a work information management system 100a according to a second embodiment of the present invention will be described with reference to FIG. 4. Note that the present embodiment differs from the first embodiment only in some configuration of the work information management system 100, and thus description of the same items as in the first embodiment will be omitted.

In the present embodiment, communication devices 25 and 5, which can perform wireless communication with each other, are mounted on a work information server 20a and each construction machine 1a, respectively. The communication device 25 includes an interface circuit that performs wireless communication with the communication device 5 under the control of a data processing unit 24a. The communication device 5 of the construction machine 1a includes a memory, a processor, an interface circuit, and the like. The communication device 5 can cause a display device 6 such as a liquid crystal display provided in a cab 3a of the construction machine 1a or the like to display information received by the interface circuit from the work information server 20a.

In this case, in the present embodiment, in response to a predetermined operation in the work information server 20a, or in response to a request output from the communication device 5 in response to a predetermined operation in the construction machine 1a, the data processing unit 24a transmits a history of work information (information group) stored in the third storage unit 23 to the communication device 5 of the construction machine 1a via the communication device 25. Then, the communication device 5 of the construction machine 1a causes the display device 6 of the construction machine 1a to display the received work information. With this operation, the history of the work information can be checked on the display device 6 of the construction machine 1a.

Note that in this case, the data processing unit 24a of the work information server 20a may transmit only the work information corresponding to the transmission target construction machine 1a to the construction machine 1a, the work information being included in the history of the work information (information group) stored in the third storage unit 23.

### Third Embodiment

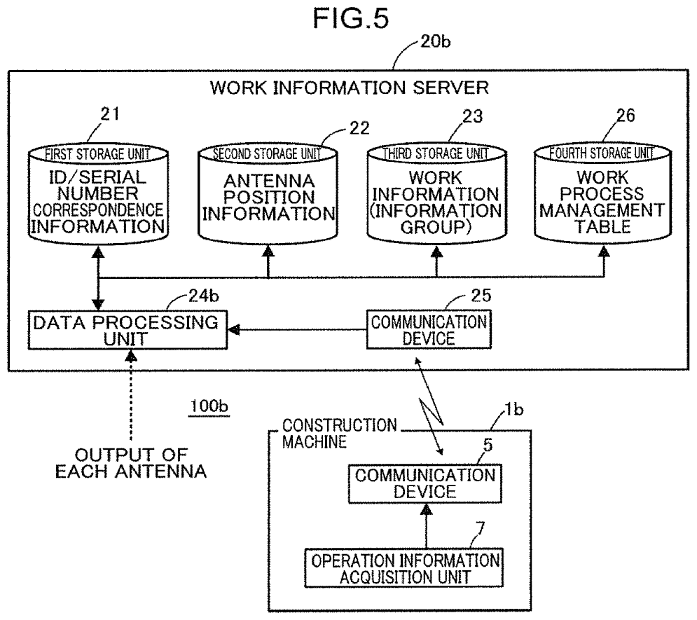

Next, a work information management system 100b according to a third embodiment of the present invention will be described with reference to FIG. 5. Note that the present embodiment differs from the first embodiment only in some configuration of the work information management system 100, and thus description of the same items as in the first embodiment will be omitted.

In the present embodiment, in a similar manner to the work information management system 100a of the second embodiment, communication devices 25 and 5, which can perform wireless communication with each other, are mounted on a work information server 20b and each construction machine 1b, respectively. The work information server 20b further includes a fourth storage unit 26 that stores in advance a work process management table that represents a schedule of work at a work site.

In addition, each construction machine 1b includes an operation information acquisition unit 7 that acquires operation information indicating an actual operation state of a work device 4 (or actual operation state of the work device 4 and a slewing body 3) via various sensors and the like provided in the construction machine 1b. The operation information acquisition unit 7 includes, for example, an electronic circuit unit including a microcomputer, a memory, an interface circuit, and the like. Note that the operation information acquisition unit 7 may include a function of controlling the operation of the construction machine 1b and the like.

In the present embodiment, when receiving ID information and antenna identification information from any antenna device 15, a data processing unit 24b of the work information server 20b transmits a request signal to request transmission of the operation information at reception time of the ID information and the antenna identification information (in other words, the time when the event occurs) or a time range near the reception time to the operation information acquisition unit 7 of the construction machine 1b corresponding to the ID information via the communication devices 25 and 5.

In response to the request signal, the operation information acquisition unit 7 of the construction machine 1b transmits the operation information requested to be transmitted by the request signal received by the communication device 5 to the work information server 20b via the communication device 5. With the transmission, the data processing unit 24b acquires the operation information transmitted by the communication device 5 via the communication device 25.

Furthermore, the data processing unit 24b acquires, from the fourth storage unit 26, data of the work process management table at the reception time of the ID information and the antenna identification information or in the time range near the reception time. Then, the data processing unit 24b stores, in the third storage unit 23, the operation information acquired from the construction machine 1b and the work process management data acquired from the fourth storage unit 26 in association with the work information (information group).

In this way, the operation information and the work process management data stored in the third storage unit 23 in association with the work information (information group) can be output from the work information server 20b together with the work information history.

With this configuration, in addition to determining the history of the occurrence of the event of the construction machine 1b approaching the monitoring target position (disposition position of the antenna device 15), an administrator, responsible person, or the like of the work site can refer to the actual operation information of the construction machine 1b at the time of occurrence of the event or near the time and the data of the work process control table.

Furthermore, it is possible to determine whether the operation state of the construction machine t b at the time of occurrence of the event is an appropriate operation state, the progress status of the work at the time of occurrence of the event, and the like. As a result, it is possible to accurately review the work process and the like.

Note that the present invention is not limited to the embodiments described above. Several other embodiments will be described below.

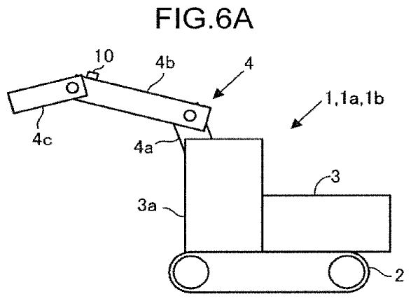

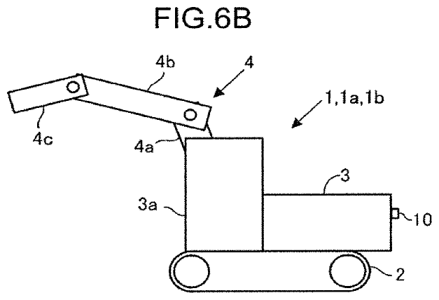

In each of the above-described embodiments, the ID tag 10 (transmission unit) is attached to the attachment 4c of the work device 4 of each of the construction machines 1, 1a, and 1b. However, the ID tag 10 (transmission unit) may be attached, for example, to the tip of the arm 4b of the work device 4 as shown in FIG. 6A. When configured in this way, without having to reattach the ID tag 10 to the construction machine 1, 1a, or 1b (while maintaining the correspondence between the construction machine 1, 1a, or 1b and the ID information), the attachment 4c can be replaced with various types of attachment.

When it is necessary to monitor the operation of the slewing body 3 of the construction machine 1, 1a, or 1b, instead of attaching the ID tag 10 (transmission unit) to the work device 4, or in addition to attaching the ID tag 10 (transmission unit) to the work device 4, for example, as shown in FIG. 6B, the ID tag 10 (transmission unit) may be attached to a predetermined part of the slewing body 3, for example, to a rear part.

In each of the above-described embodiments, the ID tag 10 is used as the transmission unit. However, the transmission unit may be a unit that can transmit a wireless signal such as, for example, Bluetooth (registered trademark) or Wi-Fi (registered trademark) to the antenna device 15.

In each of the above-described embodiments, the work information (information group) stored in the third storage unit 23 (work information storage unit) includes: the position information indicating the monitoring target position when the event occurs that the tip (attachment 4c) of the work device 4 of any construction machine 1, 1a, or 1b approaches any monitoring target position (disposition position of any antenna device 15); the serial number information of the construction machine 1, 1a, or 1b that has generated the event; and the time information indicating the time of occurrence of the event (reception time of the ID information by the antenna device 15).

However, the work information (information group) to be stored in the third storage unit 23 (work information storage unit) is required at least to include information based on at least one of the ID information and the antenna identification information. In other words, the work information to be stored in the third storage unit 23 may not include either one of the position information (predetermined information) associated with the antenna identification information or the serial number information (predetermined information) associated with the ID information.

For example, instead of the serial number information, the work information including the ID information (information group) may be stored in the third storage unit 23. Together with the history of the work information, in the ID/serial number correspondence information stored in the first storage unit 21, the serial number information associated with the ID information included in the work information may be referred to at any time. Instead of the position information associated with the antenna identification information, the antenna identification information may be stored in the third storage unit 23. Together with the history of the work information, in antenna position information stored in the second storage unit 22, the position information associated with the antenna identification information included in the work information may be referred to at any time.

Furthermore, in each of the above-described embodiments, the hydraulic excavator is exemplified as the construction machine 1, 1a, or 1b, but the present invention can be applied to construction machines other than the hydraulic excavator (for example, a crane).

### Conclusion of Embodiment

Technical features of the present embodiment can be summarized as follows.

A construction machine work information management system according to the present embodiment includes: a server; a transmission unit attached to the construction machine and configured to transmit a wireless signal indicating first identification information for identifying the transmission unit itself; and a plurality of reception units disposed at a plurality of monitoring target positions at a work site of the construction machine, the reception units being configured to receive the wireless signal when the construction machine approaches. When receiving the wireless signal, each of the plurality of reception units transmits second identification information for identifying the reception unit itself to the server together with the first identification information indicated by the received wireless signal. The server includes: a work information storage unit; and a data processing unit configured to store, in the work information storage unit, an information group in which predetermined information based on at least one of the received first identification information and the second identification information and time information indicating time of the reception are associated with each other, every time the first identification information and the second identification information are received from each of the reception units.

At many work sites, in order to appropriately manage the progress of work, details of the work, and the like by the construction machine, in particular, it is often important to be able to determine the movement of the construction machine near a specified position at the work site.

With this configuration, when an event occurs that any construction machine at the work site approaches any one of the plurality of monitoring target positions, the reception unit disposed at the monitoring target position approached by the construction machine receives the first identification information for identifying the transmission unit transmitted from the transmission unit attached to the construction machine, and transmits the first identification information and the second identification information for identifying the reception unit to the server.

Therefore, receipt of the first identification information and the second identification information by the server indicates occurrence of the event that, at the work site, the transmission unit identified by the first identification information approaches the reception unit identified by the second identification information. Then, the information group corresponding to each generated event is stored in the work information storage unit.

In this case, the information group includes the predetermined information based on at least one of the first identification information and the second identification information, and the time information indicating the reception time of the first identification information and the second identification information, as information associated with each other. Therefore, by referring to the information group stored in the work information storage unit, it is possible to easily determine useful information about when the event has occurred by the construction machine to which the transmission unit identified by the first identification information is attached, or when the event has occurred at the monitoring target position where the reception unit identified by the second identification information is disposed.

Therefore, this configuration makes it possible to efficiently and appropriately determine the work status of the construction machine at the work site.

In the above-described configuration, the predetermined information preferably includes the first identification information or intrinsic information of the construction machine associated with the first identification information.

With this configuration, by referring to the information group stored in the work information storage unit, it is possible to easily determine useful information about when the event has occurred by the construction machine indicated by the intrinsic information associated with the first identification information received by the server. This makes it possible to more accurately determine the work status of the specified construction machine at the work site.

In the above-described configuration, preferably, the server includes a first storage unit configured to store the first identification information and intrinsic information of the construction machine to which the transmission unit that transmits the wireless signal indicating the first identification information is attached in association with each other in advance, the predetermined information is the intrinsic information of the construction machine, and in the first storage unit, the data processing unit acquires the intrinsic information of the construction machine associated with the received first identification information, and includes the acquired intrinsic information in the predetermined information.

With this configuration, without configuring the plurality of reception units to be disposed at the work site and the transmission unit to be attached to the construction machine so as to transmit, to the server, the intrinsic information of the construction machine to which the transmission unit is attached, in the server, the data processing unit can easily acquire the intrinsic information of the construction machine associated with the first identification information received from each reception unit from the first storage unit.

In the above-described configuration, the predetermined information preferably includes the position information indicating a disposition position of each of the reception units, the position information being associated with the second identification information.

With this configuration, by referring to the information group stored in the work information storage unit, it is possible to easily determine useful information about when the event has occurred at the monitoring target position where the reception unit identified by the second identification information received by the server is disposed. This makes it possible to more accurately determine the work status of the construction machine at the specified position at the work site.

In the above-described configuration, preferably, the server includes a second storage unit that stores the second identification information and the position information indicating the disposition position of each of the reception units identified by the second identification information in association with each other in advance, and in the second storage unit, the data processing unit acquires the position information associated with the received second identification information, and includes the acquired position information in the predetermined information.

With this configuration, even without configuring the plurality of reception units disposed at the work site so as to transmit the position information indicating the disposition position of the reception unit to the server, the data processing unit can easily acquire the position information associated with the second identification information received from each reception unit from the second storage unit in the server.

In the above-described configuration, when the construction machine includes a travelling body, a slewing body rotatably mounted on the travelling body, and a work device mounted on the slewing body so as to be movable with respect to the slewing body, the transmission unit is preferably attached to at least one of the slewing body and the work device.

That is, substantial work by the construction machine including the travelling body, the slewing body, and the work device is often work involving operations of both or one of the work device and the slewing body. Therefore, with this configuration, the history of the information group that is more useful in determining the actual action status at the work site can be stored and held in the work information storage unit.

In the above-described configuration, when the work device includes a boom extended from the slewing body, an arm extended from a tip of the boom, and an attachment attached to a tip of the arm, the transmission unit is preferably attached to the tip of the arm.

It is assumed that the work device includes the boom, the arm, and the attachment. In this case, the attachment is generally replaced with various types of attachment according to details of the work at the work site. In this case, with this configuration, since the transmission unit is attached to the tip of the arm, even if the attachment is replaced, the transmission unit attached to the tip of the arm can be used as it is.

By attaching the transmission unit to the tip of the arm, the transmission unit can be disposed at a position close to the attachment serving as a work subject.

Note that in the above configuration, for example, an ID tag can be used as the transmission unit.

1.-7. (canceled)

8. A construction machine work information management system, comprising:
a server;
a transmission unit attached to the construction machine and configured to transmit a wireless signal indicating first identification information for identifying the transmission unit itself; and
a plurality of reception units disposed at a plurality of monitoring target positions at a work site of the construction machine, the reception units being configured to receive the wireless signal when the construction machine approaches,
wherein when receiving the wireless signal, each of the plurality of reception units transmits second identification information for identifying the reception unit itself to the server together with the first identification information indicated by the received wireless signal, and
wherein the server includes:
a work information storage unit, and
a data processing unit configured to store, in the work information storage unit, an information group in which predetermined information based on at least one of the received first identification information and the second identification information and time information indicating time of the reception are associated with each other, every time the first identification information and the second identification information are received from each of the reception units.

9. The construction machine work information management system according to claim 8, wherein the predetermined information includes the first identification information or intrinsic information of the construction machine associated with the first identification information.

10. The construction machine work information management system according to claim 8, wherein
the server further includes a first storage unit configured to store the first identification information and intrinsic information of the construction machine to which the transmission unit that transmits the wireless signal indicating the first identification information is attached in association with each other in advance,
the predetermined information is the intrinsic information of the construction machine, and
in the first storage unit, the data processing unit acquires the intrinsic information of the construction machine associated with the received first identification information, and includes the acquired intrinsic information in the predetermined information.

11. The construction machine work information management system according to claim 8, wherein the predetermined information includes position information indicating a disposition position of each of the reception units, the position information being associated with the second identification information.

12. The construction machine work information management system machine according to claim 11, wherein
the server further includes a second storage unit that stores the second identification information and the position information indicating the disposition position of each of the reception units identified by the second identification information in association with each other in advance, and
in the second storage unit, the data processing unit acquires the position information associated with the received second identification information, and includes the acquired position information in the predetermined information.

13. The construction machine work information management system according to claim 8, wherein the construction machine includes a travelling body, a slewing body rotatably mounted on the travelling body, and a work device mounted on the slewing body so as to be movable with respect to the slewing body, and the transmission unit is attached to at least one of the slewing body and the work device.

14. The construction machine work information management system according to claim 13, wherein the work device includes a boom extended from the slewing body, an arm extended from a tip of the boom, and an attachment attached to a tip of the arm, and the transmission unit is attached to the tip of the arm.
